(19) United States
(12) Patent Application Publication
(10) Pub. No.: US 2003/0224824 A1
(43) Pub. Date: Dec. 4, 2003

(54) Radio configuration and control of computer subsystems

(76) Inventor: George E. Hanson, Andover, KS (US)

Correspondence Address: LSI LOGIC CORPORATION, 1621 BARBER LANE, MS: D-106 LEGAL, MILPITAS, CA, 95035, US

(21) Appl. No.: 10/160,868

(22) Filed: May 31, 2002

(51) Int. Cl. H04M 1/00

(52) U.S. Cl. 455/560; 455/557

(57) ABSTRACT

Disclosed is a system and method that employs radio communication to transfer information between modular components removably installed in a cabinet such as may be employed for storage systems. Radio signals may be confined to the interior of the cabinet. Other radio signals may communicate from the cabinet to external monitoring equipment. A radio transceiver and antenna are provided as part of each modular component. A master unit may enumerate components, determine type, model, versions of components and may monitor operating conditions that may comprise voltage, current, temperature, fan rotation rate, data throughput and other variables. The master unit may process acquired information, may store information, or may transfer information to another system for processing.

### BACKGROUND OF THE INVENTION

a. Field of the Invention

The present invention pertains to computer subsystems and more specifically to storage systems and a method of employing radio communication to control and configure the components of the system

b. Description of the Background

Storage systems typically comprise a number of components including an array of disk drives, disk drive controllers, power supplies and interface cabling. Systems are often redundant in that there are duplicate controllers, duplicate power supplies and duplicate buses interconnecting controllers, drive arrays, and power supplies. Systems are constructed to be readily maintainable and upgradeable. Various components of the system may be replaced while the system continues to operate. For example, if a power supply failure occurs, the failed power supply may be replaced while the system continues to operate using another functioning power supply or power supplies. Similarly, if a controller fails, the system may continue to operate using another functioning controller while the failed unit is replaced. These capabilities are often realized through a modular architecture. Typically, various modules comprising disk drives, controllers, power supplies and such, are disposed in a single cabinet or housing. The modules are removable and hence may be termed customer removable units. The cabinet provides connections between the various modules and includes various cables and connectors. Connections to modules include power connections, data and control connections, and may include presence detectors, fault indicators, and a vital product information bus, such as I²C, for example. The monitoring of presence, faults, and vital product information allows the reliability of the system to be enhanced. For example, power supplies may include fault signals that are activated when voltages are outside of predetermined limits, possibly indicating that the power supply is about to fail. Replacement of power supplies having voltages that are outside a predetermined range may extend the operational life of components powered by the power supply unit. Fan speeds may be monitored to determine when fan failure has occurred or is likely to occur. Backup batteries may provide time information to indicate a replacement date.

The presence detection, fault indication, and vital product information connections provided in the cabinet for each module result in significant additional wiring beyond that of typical power and data/control bus interfaces. This additional wiring is a potential point of failure and while not directly affecting data integrity, it affects the ability to monitor operation of the system and to perform system checks. Redundant monitoring further requires that such wiring be provided to multiple monitoring units. Also, the additional wiring may employ dedicated signal lines, such as presence and fault indication, for example, wherein the hard wiring of signals limits the number and type of components that may be installed in a particular slot, tray, or bay of a modular electronic system. The wiring requirements may also limit the configurations, upgrades, and maintenance options for a particular cabinet architecture. Due to the aforementioned limitations regarding reliability, maintenance and configuration, a new method for communicating module information is needed.

### SUMMARY OF THE INVENTION

The present invention overcomes the disadvantages and limitations of the prior art by providing in-cabinet wireless radio communication between modular components of a modular electronic system. The radio interface is typically a low power interface and signals may be limited to the interior of a cabinet or other enclosure.

The present invention therefore may comprise a method of in-cabinet communication in a cabinet based modular electronic system comprising: removably installing at least two modules in the cabinet, each module having a radio transceiver and an antenna that is located internally in the cabinet when the module is installed, wherein the cabinet limits radio signal emissions outside the cabinet; designating one module of the at least two modules as a master module; establishing a communication link between the master module and at least one other module in the cabinet; and transferring information from the at least one other module to the master module.

The invention may further comprise a modular electronic system employing in-cabinet radio communication to communicate between modules comprising: a controller module comprising a radio transceiver and antenna disposed in the cabinet wherein the antenna is internal to the cabinet, the cabinet limiting the transmission of radio signals external to the cabinet; at least one other module comprising a second radio transceiver and second antenna disposed in the cabinet wherein the second antenna is internal to the cabinet; and a software program operating on the controller module that allows the controller module to communicate with the at least one other module.

The present invention may additionally comprise a removably installable module for a modular electronic system employing in-cabinet radio communications comprising: a housing for the module that allows the module to be removably inserted in the modular system cabinet; a connector providing transfer of power between the module and the cabinet; a radio transceiver disposed in the module; an antenna attached to an external portion of the module housing wherein the antenna is internal to the cabinet when the housing is installed in the cabinet; and a microprocessor that executes a software program that sends and receives data using the radio transceiver.

Advantageously, the present advantage provides the flexibility in assembling, configuring, maintaining, and upgrading systems without being limited by status bus architectures.

### DESCRIPTION OF THE FIGURES

In the figures,

FIG. 1 is a depiction of a storage system with power and data/control buses.

FIG. 2 depicts a storage system employing a status bus.

FIG. 3 depicts a storage system employing a radio communications interface.

FIG. 4 is a flowchart of tasks performed by a master unit.

### DETAILED DESCRIPTION OF THE INVENTION

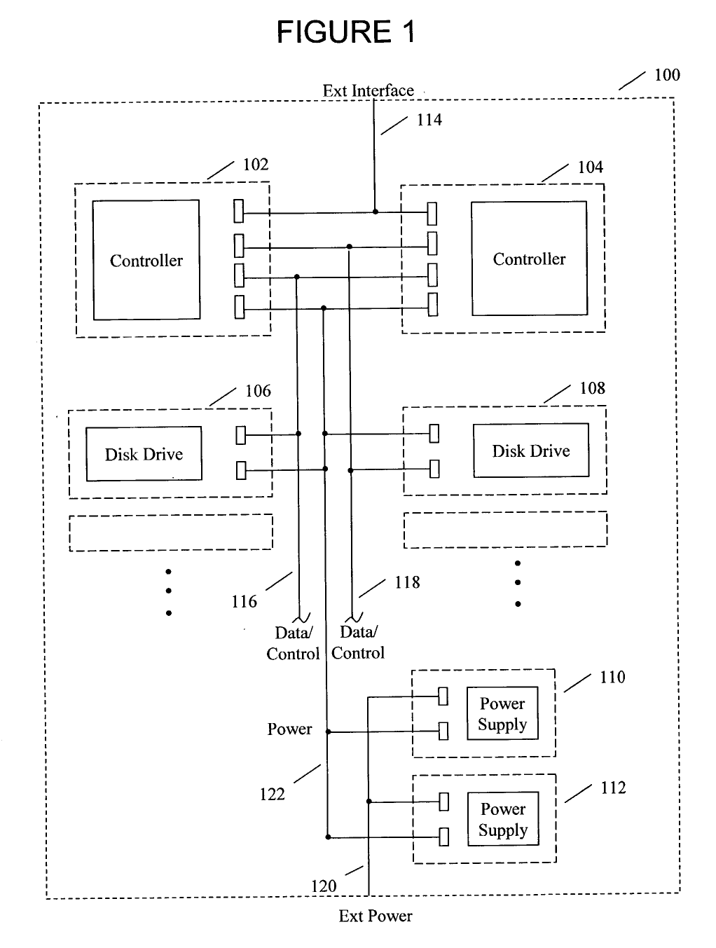

FIG. 1 is a depiction of a storage system with power and data/control buses. Storage system 100 comprises controllers 102, 104, disk drive arrays 106, 108, and power supplies 110, 112. Power bus 120 provides power to the controllers and drive arrays. Controller 102 is connected to disk drive array 106 through a first data/control bus 116 and to disk drive array 108 through a second data/control bus 118. Controller 102 communicates data to an external system through external interface 114. This interface may comprise an Ethernet bus, SCSI (Small Computer Systems Interface) bus, fibre channel connection, or other type of interface, either serial or parallel. Similarly, controller 104 is connected to disk drive array 106 through first data/control bus 116 and to disk drive array 108 through second data/control bus 118. Controller 102 also communicates data to an external system through external interface 114. In some implementations, controller 102 and controller 104 may employ separate interfaces (not depicted) to communicate data to an external system. Controllers 102, 104 each employ one or more connectors to receive power and to interface to first data/control bus 116, second data/control bus 118, and external interface 114. Controllers 102, 104 may support RAID (Random Array of Independent Disks) storage control functions. Disk drive arrays 106, 108 each employ one or more connectors to receive power and to interface to first data/control bus 116 or second data/control bus 118. Although not depicted, in some implementations, disk drive arrays may interface to both first data/control bus 116 and second data/control bus 118. Power supplies 110 and 120 receive external power from external power bus 120. Power bus 120 may supply line voltages such as 120 or 240 volts AC as is common in North America, or may supply other voltages in different countries. Power supplies 110 and 120 convert the voltage from power bus 120 to a voltage or voltages used by controllers 102, 104 and disk drive arrays 106, 108 and outputs the voltage (or voltages) on power bus 122.

Storage systems are typically modular in architecture such that failed components may be readily replaced or additional components added to repair or upgrade the system. The storage system may comprise a cabinet with slots or bays into which controller, disk drive and power supply modules may be installed. Connectors on each module provide an interface to power and/or data/control signals. Managing the storage system requires knowledge of what modules are installed including the type of module, version or model number, serial number, and operating status. Further an “in place line” signal indicates that a module is installed. The buses and signals lines employed to convey module information may be collectively referred to as a status bus.

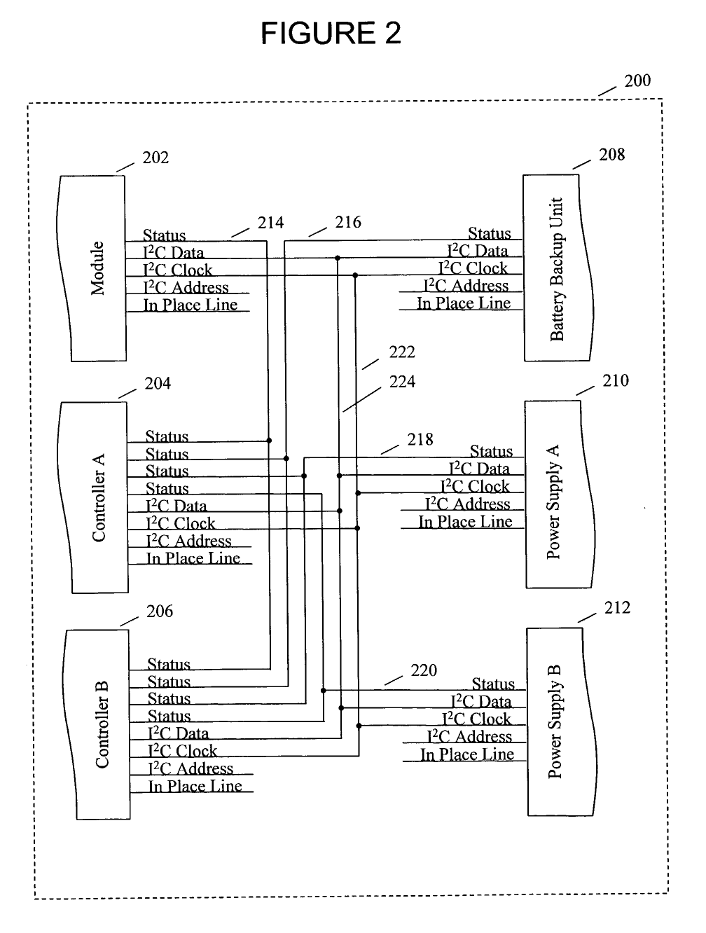

FIG. 2 depicts a storage system employing a status bus. System 200 comprises module 202, first controller 204, second controller 206, battery backup unit 208, first power supply 210 and second power supply 212. Status lines 214, 216, 218, and 220 connect module 202, battery backup unit 208, first power supply 210, and second power supply 212 respectively to first controller 204 and second controller 206. The depicted status lines may comprise a plurality of signals each, and may convey information such as operating condition, fault indication, and other information. An I²C bus comprising I²C clock line 222 and I²C data line 224 interconnects all depicted components. I²C is a two-wire bus developed by Philips Corporation, headquartered in Eindhoven, The Netherlands, and is a de-facto standard for embedded solutions. The I²C bus may be employed to convey information such as component type, model, version, serial number, date placed in service, and other information. I²C address lines shown for each component are employed to define the address of that component. Module 202 depicted in FIG. 2 may be a disk drive, an array of disk drives, a drive tray comprising an array of disk drives with local controller, a CD-ROM drive or array of drives, tape unit, ESM unit, or any other component that may be employed in a cabinet based system. Large storage systems may comprise many modules supporting hundreds of drives. As the complexity of the system increases, the complexity of the status bus also increases as status and fault signals are supported and routed to typically at least two controllers to provide redundancy. The number of signals supported in a status bus may limit the expandability of a storage system and represents a possible point of failure that may limit system operation, maintenance, or upgrading.

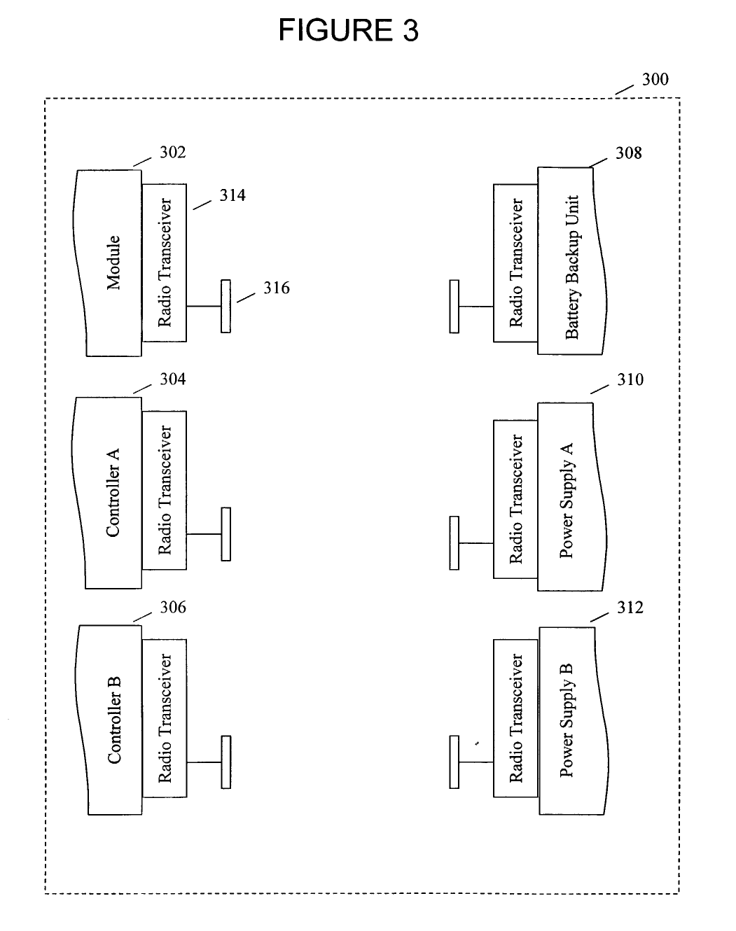

FIG. 3 depicts a storage system employing a radio communications interface. System 300 comprises module 302, first controller 304, second controller 306, battery backup unit 308, first power supply 310 and second power supply 312. A data/control bus and a power bus as shown in FIG. 1 may interconnect the components of system 300. Battery backup unit 308 may be employed to provide power to cache memories to retain data in the event of both power supplies failing or power to the cabinet, in which system 300 may be enclosed, failing. Alternatively, a non-volatile memory may be employed for cache and such architectures may omit battery backup unit 308. Module 302 includes radio transceiver 314 and antenna 316. Radio transceiver 314 and antenna 316 may be implemented such that they are part of module 302. Antenna 316 may comprise a wire, or a flat film or metal foil antenna. Antenna 316 may be disposed on a surface of module 302 or may project outward from module 302. Similar to module 302, other components in system 300 each comprise a radio transceiver and antenna. The radio transceivers are typically of lower power and system 300 is typically enclosed in a cabinet that limits radiation of radio signals external to the cabinet. The cabinet may include surfaces or other structures that promote radio communication between the components in the cabinet. In addition to the transceivers and antennas providing communications within the cabinet, an antenna (not depicted) may be provided external to the cabinet to provide communication to an external system. Such communications may occur at regular intervals, or may be performed on a demand basis, as may occur if a user employs a laptop, handheld, palm or other device to access information regarding a system contained in a cabinet or other enclosure. Advantageously, the present invention removes architectural limitations of wired architectures, allowing greater flexibility in system configuration. Further, as systems evolve, new components and new types of information may be supported without requiring additional or new wiring. By removing bus limitations, the present invention provides greater flexibility or use of slots or bays into which modules may be installed. This may provide cost savings in that a single cabinet design may be employed to produce a wider range of systems. Module radio interfaces may be tested prior to installing the module, eliminating possible problems of connector alignment, poor contact, and degradation of contacts over time.

A bus, as depicted in FIG. 1, may interconnects first controller 304 and second controller 306 and may allow either controller to access modules and to send and receive data and other information to external systems. In one embodiment of the present invention, controller 304 assumes the role of a radio communications master and components in the system serve as slave communication units, including second controller 306. If after some period of time second controller 306 does not receive a radio communication from first controller 304, second controller 306 may be configured to serve as master, providing redundant communication in the event of a failure in first controller 304 or in the transceiver and antenna associated therewith.

In another embodiment of the present invention, a controller may first monitor radio communications to determine if another master exists. Such may be the case when a failed controller has been replaced while another installed controller continues to operate. In a further embodiment of the present invention, controllers may contain software that monitors radio communications for a random period of time and if no communications occur within the random period, the controller may issue communications as master unit.

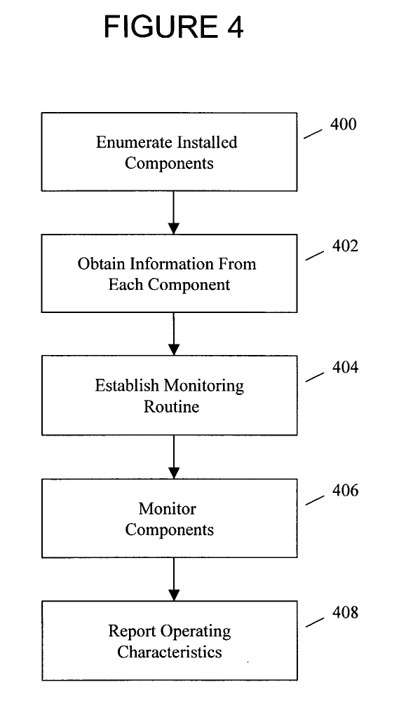

In operation, the master unit polls other components in the system to determine what components are installed, how they are configured, and the status of the component. FIG. 4 is a flowchart of tasks performed by a master unit. The master unit, typically a controller in the system, may enumerate devices and determines their configuration. At step 400, the master enumerates the devices in the system. Enumeration may comprise identifying installed components and the addresses at which they may be accessed. At step 402, the master obtains status information from each component. Such information may comprise voltages, currents, temperatures, dates of installation, fan rotation rate, and other information. At step 404 a monitoring routine is established. The monitoring routine comprises what information is monitored and how often values are reported. At step 406 the components are monitored. This may include comparing present values with previous values, as may indicate a weak power supply or fan that may be degrading in performance. Further, monitoring may include performance information such as data transfer rates, packet rates, latencies and the like. At step 408, operating characteristics are reported and may be stored. Operating characteristics may be reported to an external system such as a terminal or other computer equipment.

The present invention may employ radio formats that correspond to the Bluetooth™ Specification. Bluetooth in an industry specification supported by a consortium of companies through Bluetooth SIG Inc. Bluetooth is a low power spread spectrum radio interface specification intended to operate over distances up to 30 meters. As such, Bluetooth is well suited to the in-cabinet communications of the present invention. The present invention is not limited to this particular standard and may employ Bluetooth and other technologies including those developed for other digital wireless communication systems including cellular telephones, digital messaging systems, and radio local area networks (LANs). The disclosure of the invention has employed the term cabinet to describe a structure into which modules may be removably installed. This term encompasses rack systems, drawer systems, computer expansion cases and any other similar structure in which a module having a similar form factor may replace another module. The cabinet may include cover plates, doors, panels, or other surfaces that limit radiation of radio signals.

Advantageously, the present invention provides a new method for communicating with components in a system and for monitoring the performance of components. The radio communication of the present invention eliminates the shortcomings of wired buses such as the number of components that may be installed, the detail and type of information that may be conveyed, and also reduces the cost of cabinet wiring. The present invention provides flexibility in the assembly, maintenance and upgrade of electronic systems because system configuration is not limited by the capabilities of an internal bus. This may provide a longer useful life for cabinets in that newer versions of modules may be installed and are not limited by the internal bus architecture. The present invention may also provide higher data rates than wired architectures, allowing more frequent update of monitored information or the transfer of more detailed information.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

I claim:

1. A method of in-cabinet communication in a cabinet based modular electronic system comprising:
removably installing at least two modules in said cabinet, each module having a radio transceiver and an antenna that is internal to said cabinet when said module is installed, wherein said cabinet limits radio signal emissions outside said cabinet;
designating one module of said at least two modules as a master module;
establishing a communication link between said master module and at least one other module in said cabinet; and
transferring information from said at least one other module to said master module.

2. The method of claim 1 wherein said master module is a storage controller module.

3. The method of claim 1 wherein said at least one other module is a disk drive module.

4. The method of claim 1 wherein said at least one other module is a power supply module.

5. The method of claim 1 wherein said information comprises temperature information.

6. The method of claim 1 wherein said information comprises voltage information.

7. The method of claim 1 wherein said information comprises fan operating information.

8. A modular electronic system employing in-cabinet radio communication to communicate between modules comprising:
a controller module comprising a radio transceiver and antenna disposed in said cabinet wherein said antenna is internal to said cabinet, said cabinet limiting the transmission of radio signals external to said cabinet;
at least one other module comprising a second radio transceiver and second antenna disposed in said cabinet wherein said second antenna is internal to said cabinet; and
a software program operating on said controller module that allows said controller module to communicate with said at least one other module.

9. The system of claim 8 further comprising:
a power supply.

10. The system of claim 8 further comprising:
a second controller module.

11. The system of claim 8 wherein said at least one other module comprises:
a disk drive module.

12. The system of claim 8 wherein said at least one other module comprises:
an environmental services monitor module.

13. The system of claim 8 wherein said radio transceiver has a transmitting power of less than two milliwatts.

14. The system of claim 8 wherein said radio transceiver conforms to standards known as Bluetooth.

15. A removably installable module for a modular electronic system employing in-cabinet radio communications comprising:
a housing for said module that allows said module to be removably inserted in said modular system cabinet;
a connector providing transfer of power between said module and said cabinet;
a radio transceiver disposed in said module;
an antenna attached to an external portion of said module housing wherein said antenna is internal to said cabinet when said housing is installed in said cabinet; and
a microprocessor that executes a software program that sends and receives data using said radio transceiver.

16. The module of claim 15 wherein said radio transceiver has a transmitting power of less than two milliwatts.

17. The module of claim 15 wherein said radio transceiver conforms to standards known as Bluetooth.

18. The module of claim 15 further comprising:
a disk drive.

19. The module of claim 15 further comprising:
a power supply.

20. The module of claim 15 further comprising:
a RAID controller.
